(19) United States
(12) Patent Application Publication
(10) Pub. No.: US 2011/0185378 A1
(43) Pub. Date: Jul. 28, 2011

(54) Systems For Rich Media Channel Distribution

(76) Inventor: Moses Johnson, Philadelphia, PA (US)

(21) Appl. No.: 13/010,035

(22) Filed: Jan. 20, 2011

Related U.S. Application Data
(60) Provisional application No. 61/313,307, filed on Mar. 12, 2010.
(60) Provisional application No. 61/299,188, filed on Jan. 28, 2010.

(51) Int. Cl. H04N 7/16; H04N 5/445; H04N 7/10

(52) U.S. Cl. 725/25; 725/56; 725/32

(57) ABSTRACT

A media distribution system is presented. A channel producer can access a channel distribution portal to construct one or more channels of rich media content. Channels are defined by one or more media arrangement requirements including a schedule for presenting content, placement of content, orientation of content, layers of content, or other requirements. The arrangement can be compiled into media player commands, which can be sent to subscribing media players. The media players present the channel content according to the compiled arrangement in a manner where each media player presents the channel content substantially at the same time. The system can be used to simulate a shared television viewing experience among cell phone users.

This application claims the benefit of priority to U.S. provisional application having Ser. No. 61/313,307 filed Mar. 12, 2010, and to U.S. provisional application having Ser. No. 61/299,188 filed on Jan. 28, 2010. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is rich media distribution technologies.

### BACKGROUND

Some portable media playing devices (e.g., cell phones, MP3 players, DVD players, web browsers, gaming systems, etc.) merely re-play recorded media. Unfortunately, such devices lack an ability to create a truly rich, dynamic media experience. While useful in replaying a favorite media file, there is little opportunity for advertisers to present promotions to the media viewer during playback.

Other portable devices, including some cell phones, comprise a television tuner or a radio tuner and can present broadcasts to a viewer. As is typical with broadcasts, the broadcasts can include commercials. Unfortunately, such portable devices lack sufficient reception capabilities for presentation of clear content as the portable device changes locations where reception is weak. Additionally, the broadcasts are under control of networks rather than individuals.

Some services allow individuals to customize a play list of content (e.g., Muzu.tv, YouTube™'s Music Discovery Project and Playlist Creation Tool, Google TV, etc.). However, the user lacks an ability to share content with other users according to a schedule similar to the experience generated by existing broadcast techniques. In a never ending quest, users of mobile device constantly seek out new media content. Examples of existing technologies that can be leveraged for providing content to cell phone users include the following references.

U.S. patent application publication 2008/0195664 to Maharajh et al. titled “Automated Content Tag Processing for Mobile Media”, filed Dec. 13, 2007, discusses using tags to control delivery.

U.S. patent application publication 2008/0200154 to Maharajh et al. titled “Mobile Media Pause and Resume”, filed Dec. 13, 2007, contemplates allowing users to pause and resume content that is played on a mobile media player.

U.S. patent application publication 2008/0207182 to Maharajh et al. titled “Encoding and Transcoding for Mobile Media”, filed Dec. 13, 2007, discusses encoding content into a desired format for remote mobile devices, possibly based on user profiles.

U.S. patent application publication 2009/0228600 to MacFarlane et al. titled “Streaming Content Provisioning Systems for Wireless Networks”, filed Oct. 10, 2009, describes facilities or utilities for streaming content to mobile devices.

U.S. patent application publication 2009/0298485 to Lee et al. titled “Methods and Apparatus for Mobile Personal Video Recorder”, filed May 17, 2007, describes recording content on a remote server, possibly controlled by a mobile device.

International patent application publication WO 2007/149099 to Smith et al. titled “Method and Apparatus for Creating and Viewing Customized Multimedia Segment”, filed Jun. 23, 2006, discusses using metadata to identify events within in-band data and taking a corresponding action when the event is satisfied.

Interestingly, the approaches taken to date relating to providing a rich media experience targeting mobile devices utilizes monolithic programmed content. It has yet to be appreciated that content can be fully dynamic where units of content can be layered or combined as desired by a content producer then delivered and played back within a channel. The channel can include the programmed content and can include media player control commands that instruct a media player how to play units of content. The commands can also include viewer locks that restrict how a content viewer can, if possible, adjust playback of the content.

In a more ideal media distribution environment, the environment would allow content to be played in a manner that is robust against device movement even in low connectivity areas, and allow individuals to create their own channels of scheduled content or their own media network. Rather than broadcasting content as in television or radio, content can be buffered in a portable device and played by a media player configured to play the content according to a schedule. Buffering content ensures that the content can played while a device moves from one location to another. Furthermore, the buffer can be secured against viewer access to aid in protecting rights of content owners. Individuals can also construct their own channels of content for broadcast to remote subscribers through a media channel construction portal. The portal allows an individual to arrange content to create their own channel and the portal can further utilize a channel server to deliver the content to multiple subscribers. The system can be further enhanced by allowing media players to receive updated schedules to allow for public service announcements, just-in-time advertisements, or other dynamic changes.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

Thus, there is still a need for rich media distribution systems.

### SUMMARY OF THE INVENTION

The inventive subject matter provides apparatus, systems and methods in which one can utilize a media channel distribution portal to create a broadcast channel comprising one or more layers of rich media. A heterogeneous mix of media players can request one or more channels of media content and the portal will broadcast compiled channel content to the players. One aspect of the inventive subject matter includes a media distribution portal. The portal represents an infrastructure allowing individual channel producers to compile arrangements of content. The portal can include a channel database configured to store compiled arrangements of channel content. A channel's arrangement includes arrangement requirements, for example, positional requirements, timing requirements, orientation requirements, or other requirements relating to playback of the channel content. A compiled arrangement can be considered to represent a channel. A channel producer leverages a channel producer interface of the portal to construct channels by identifying desired media content for inclusion in the channel and the arrangement requirements, which comprise a schedule. A channel server accepts the producer's desired arrangement and the identified media content, and then compiles the information into a compiled arrangement of channel content representing the producer's channel. One should note that the resulting compiled arrangement can have additional content beyond the media content identified by the producer. Example non-producer identified content can include public service announcements, just-in-time advertisements, or other types of non-producer identified content. The compiled arrangement can comprise one or more layers of the channel content. The channel server binds one or more media player commands that instruct the media players how to playback the channel content according to the compiled arrangement. Especially preferred media player commands include viewer control locks that restrict how a viewer can affect playback of the channel content. Upon receiving a request from the media players for the constructed channel, the channel server can broadcast the channel content and media player commands over a network to the media players.

In some embodiments, producers can access an a priori defined arrangement as a channel template having one or more blank media segments, time slots or display zones for example. The producer can fill in blank media segments with their desired content. Furthermore, the channel template can include pre-encoded media player commands. For example, the channel template could include instructions for playing advertisements or other promotions at specific times, instructions restricting a viewers control over playback advertisements, or instructions for managing a secure channel buffer within the media players.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic overview of a media channel distribution portal.

FIG. 2 is a schematic of a portion channel producer interface allowing a produce to schedule and identify content for a channel.

FIG. 3 is an example of a compiled arrangement of channel content having bound media player commands and viewer control locks.

FIG. 4 is a schematic of a media player having secured buffers storing channel data.

FIG. 5 is a schematic of a media player presenting a channel of layered content to a viewer.

### DETAILED DESCRIPTION

It should be noted that while the following description is drawn to a computer/server-based media channel distribution portal and channel servers, various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network or over cell networks.

One should appreciate that the disclosed techniques provide many advantageous technical effects including providing an infrastructure allowing individuals to construct distributable channels of media content. A channel producer utilizes the infrastructure to create an arrangement of content that can be sent to multiple media players and presented to all the players in a substantially synchronized fashion.

### Overview

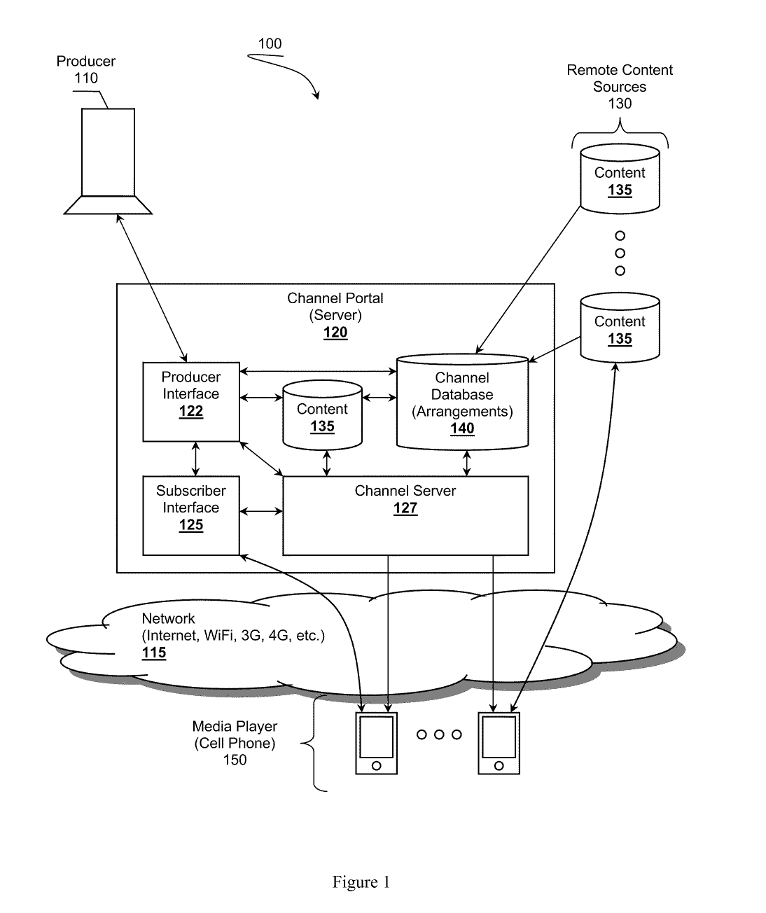

In FIG. 1, media distribution environment 100 comprises media channel distribution portal represented by channel portal 120, which can be accessed by one or more remote users over network 115. For example, producer 110 can access channel portal 120 via producer interface 122 to construct a channel, and remote users can direct their media players 150 to access the constructed channel via subscriber interface 125. The following disclosure contemplates a media delivery system where mobile devices (e.g., cell phones, game consoles, etc.) can receive digital content and present the content according to a defined arrangement including a schedule. One could utilize the platform as simulating a television experience on multiple mobile devices where channel content can be buffered before playback. Additionally, channel content can be programmed or scheduled by nearly anyone.

Channel portal 120 is presented as a single computing device operating as a server on the Internet. One should appreciate that the various components of channel portal 120 can be arranged according to different architectures while still falling within the scope of the inventive subject matter. For example, channel database 140 could be located at a remote site over network 115 relative to channel server 127.

One should further appreciate that a channel's compiled arrangement includes a schedule for presenting content, preferably a schedule having absolute time requirements on playing the media. In more preferred embodiments, media players 150 strictly, within some acceptable jitter, to adhere to the schedule. Example schedule timing requirements can include rate of playback, presentation of specific data (e.g., frame, sounds, etc.) at specific times, synchronization of layered content, or other timing criteria. The compiled arrangement can further include other requirements beyond schedule including position requirements, orientation requirements, visibility requirements, or other requirements affecting the arrangement of channel content.

Although the following discussion presents the concepts within the context of video or audio data, one should appreciate channel content can also include slides, text, tactile feed back (e.g., cell phone vibrations, etc.), games, magazines, books, or other types of media that can be presented to a user. Furthermore the terms “play” or “playback” is used euphemistically to represent presenting media to a user via media player 150 regardless of the media modality or type (e.g., video, image, audio, haptic, tactile, etc.).

Producer 110 can access a web-based content scheduling infrastructure represented by channel portal 120 to define a schedule or otherwise construct a channel of rich media, where the infrastructure comprises one or more servers, interfaces, or databases. Producer 110 can access channel portal 120 via producer interface 122 where channel portal 120 operates as a web server. Channel portal 120 instructs a web browser of producer 110 to render one or more user interfaces for use producer interface 122.

As producer 110 constructs a desired channel on channel portal 120, channel information can be stored on channel database 140. Channel database 140 is preferably configured to store one or more channels as an arrangement of media content 135 where each arrangements represents a separately manageable object. One should appreciate that channel database 140 can store channels for multiple producers 110, only allowing authorized producers 110 to gain access to permitted channels. Furthermore, each channel in channel database 140, or content 135 as well, can be tagged with attributes or other metadata describing the channel. Contemplated attributes can include channel owner, channel producer, genre, topic, free-for-use or fee-for-use, ratings or rankings, user comments or forums, or other attributes. Users of channel portal 120 can search for channels or content 135 by submitting attribute-based queries to channel server 127 operating as a channel search engine.

Content 135 represents various digital media that can be combined together for presentation via a channel and according to the arrangement defined by producer 110. Content 135 can be stored local to channel portal 120 (i.e., within a local network) or one remote content sources 130. When stored on remote content sources 130, content 135 can be referenced by URLs, URIs, APIs, or other type of address referencing content 135. One should appreciate that channel portal 120 lacks a requirement for any content to be locally available. For example, content 135 could include video game trailers located on YouTube™ or other accessible available web site.

Channels stored in channel database 140 can be in various states of release. In some embodiments, channel database 140 can store one or more channel templates representing an a priori defined arrangement having pre-defined media segments. Each media segment can represent a time slot into which content 135 can be placed. Producer 110 can start constructing a channel by requesting a channel template and filling out the time slots by identifying content 135 to be presented in the time slot. As producer 110 continues work, their channel can be saved as an object within channel database 140 as a work in progress. When finally complete or otherwise satisfied with a channel's arrangement, producer 110 can released the channel for public consumption and store the channel as a released object. In some embodiments, channel portal 120 offers a version control system allowing producer 110 to retain versions or other revisions of their channel.

Producer 110 releases their channel by instructing channel server 127 to compile their channel arrangement into a final form referenced as a compiled arrangement. The compiled arrangement defines the published form of the producer's channel. It should be appreciated the compiled arrangement does not necessarily have to match the arrangement defined by producer 110. For example, as discussed below, a channel template can retain reserved time slots for advertising where the time slots are auto-populated by channel server 127 with non-producer identified content when compiling a channel.

Remote subscribers can access released channels via subscriber interface 125. Subscribers using media player 150, or other remote users, can search for interesting channels, subscribe to channels, pay fees, or otherwise interact with channel portal 120 or channel server 127.

Upon receiving a request for a channel from media player 150, channel server 127 begins broadcasting the requested channel to the media player. The term “broadcast” is used to convey the concept of making content available to multiple media players 150 rather than in the strict sense of the term, and is used to provide a sense that the disclosed techniques can be utilized to simulate a communal, shared television viewing experience. When channel server 127 broadcasts a channel, channel server 127 provides the channel's compiled arrangement to media players 150. Media players 150 obtain the channel content from channel server 127 or from remote sources 130. It should be appreciated that the channel content can be obtained separately from the arrangement information. For example, the arrangement information can be sent to media player 150 as a serialized file representing a schedule of channel content. The channel content can be sent to media player 150 as a separate stream, or can be obtained by media player 150 from remote content sources 130.

### Content Aggregation and Scheduling

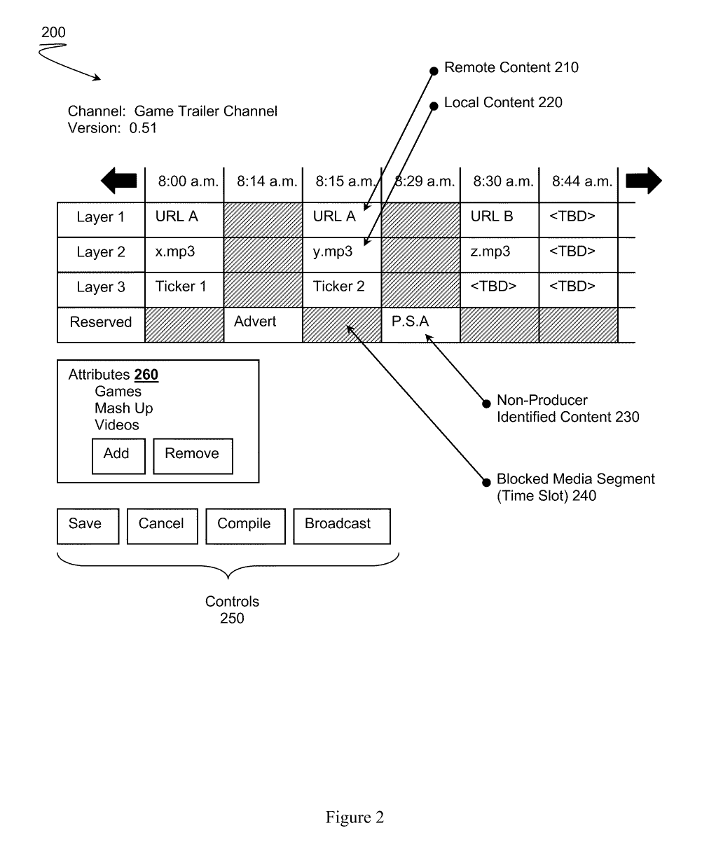

FIG. 2 presents a scheduling interface 200 as part of a producer interface, through which a producer can construct a channel's schedule or other arrangement requirements. In the example shown, a producer is generating a video channel that comprises video game trailers. As shown, the producer is in the middle of the process of populating media segments represented as time slots. The producer utilizes the producer interface to construct a channel by identifying media content to the channel server and defining an arrangement of the media content within the channel.

The producer accessing scheduling interface 200 has elected to utilize a channel template which has an a priori defined arrangement as represented by a schedule for multiple layers of content. The channel template arrangement includes blank media segments, or time slots, available to the producer. The template can further include pre-encoded media player control commands (e.g., layer positions, audio settings, orientations, play time requirements, etc.) to further simplify the producer's work. The producer can then drag and drop content, or content addresses, from various sources (e.g., local content, YouTube™, Google™, Flikr™, etc.) to populate the schedule for the producer's channel. The actual content data can be accessed or referenced by a pointer (e.g., URL, URI, API, etc.) as indicated in Layer 1 where URLs point to remote content 210. In addition, local content 220 can be referenced simply by a file name or other file handle. The producer uses scheduling interface 200 to identify desired media content to the channel server or otherwise define the arrangement for the channel. Thus, the channel server can create an arrangement of the content according to the producer's defined schedule.

A defined arrangement of media content can include one or more layers as shown. Layer 1 represents videos possibly obtained from a remote site. Layer 2 represents audio files to be played as a non-visible, yet audible content at the same time as the videos. Layer 3 presents ticker messages to be displayed repeatedly at the same time as the other layers. Finally the Reserve layer represents non-producer identified content 230 outside control of the producer. For example, the non-producer identified content 230 can include public service announcements, advertisements, or other types of content inserted by the channel server.

The arrangement of media content requires a schedule. A schedule can include time slots or other media segments arranged according to any desired format or based at different levels of time: sub-second, second, minute, hour, day, week, month, or other time frames. A schedule could also be made to repeat as desired, or could be a one-shot event. In addition, the arrangement can also include media player commands instructing a media player how to present content. The instructions can include display position, contrast or brightness adjustment, audio volume, text placement, or other instructions that dictate how to present content. For example, Layer 1 can be presented on a whole display, while Layer 2 data can override audio from Layer 2. Ticker messages can be presented as text messages that overlay the display of Layer 1. Furthermore, when data from the Reserved layer is presented, the user can be restricted from controlling the play back of the advertisements as discussed further below.

In some embodiments, the channel server can automatically analyze or “pre-compiled” the content to determine how to fit the content within the schedule. The content could be modified as necessary or desired to meet scheduling constraints. Modifications can include editing, filtering, cutting, splicing, cropping, shortening, compressing, annotating, censoring, lengthening, or otherwise changing portions of the content. Consider an example where a producer identifies remote content 210 to be presented between 8:00 a.m. and 8:30 a.m. within the channel template of FIG. 2. The channel server interprets the arrangement and determines that the remote content 210 located at URL A must fit within 28 minutes and be split within two segments: a segment from 8:00 a.m. until 8:14 a.m. and a segment from 8:15 a.m. until 8:29 a.m. The channel server can download or otherwise obtain remote content 210 and analyze remote content 210 to determine how best to fit remote content 210 to the scheduling requirements or other arrangement requirements. Alternatively, the channel server can recommend or automatically change the schedule or other arrangement requirements to accommodate the identified content.

A number of options are possible for fitting remote content 210 or local content 220 into the scheduling requirements. For local content 220 stored within the channel server, pre-compiling can be quite straightforward. Local content 220 can be broken apart logically into multiple portions to fit the timing requirements, time compressed or lengthened to fit the time slot requirements, or simply cropped short. Alternatively, the arrangement requirements can be adjusted to accommodate local content 220. For remote content 210, analysis can be more problematic.

When reviewing remote content 210, the channel server can obtain remote content 210 to determine how best to present the content, if required. One should appreciate that media players can obtain remote content 210 from remote content sources as well. The channel server might not have sufficient rights or privileges to make actual edits to remote content 210. In such a scenario, the channel server can review data associated with remote content 210 (e.g., attributes, metadata, actual content data, etc.). Rather than editing remote content 210, the channel server can generate one or more media player commands that instruct the media player to adjust its playback of remote content 210 to fit the schedule requirements. For example, the media player can simply download remote content 210 into a buffer for playback. Then, the media player reviews the media player commands associated with the channel to edit or otherwise modify remote content 210 to fit arrangement requirements when played back. The media player can compress, crop, time shift, play rate, scale, or otherwise alter remote content 210 via one or more format conversion modules to fit the arrangement requirements.

One should appreciate that time slots represent one type of media segments that reflect required play times. Other contemplated types of media segments can include positional restrictions in a display, bounding box or zone restrictions in a display, orientation restrictions, or other types of playback requirements.

In the example illustrated in FIG. 2, scheduling interface 200 represents a channel template having blocked media segments 240, which prevent a producer from assigning content to time slots reserved for advertisers. In addition, advertisers can be restricted from placing their messages in time slots available to the producer.

Although scheduling interface 200 illustrates time slots representing timing requirements as part of a channel's arrangement, other types of arrangement requirements can also be defined by a producer. Example requirements can include defined display position requirements, orientation requirements (e.g., rotation, skewing, etc.), display control requirements (e.g., contrast, brightness, filtering, scaling, etc.), volume or audio requirements, or other types of requirements.

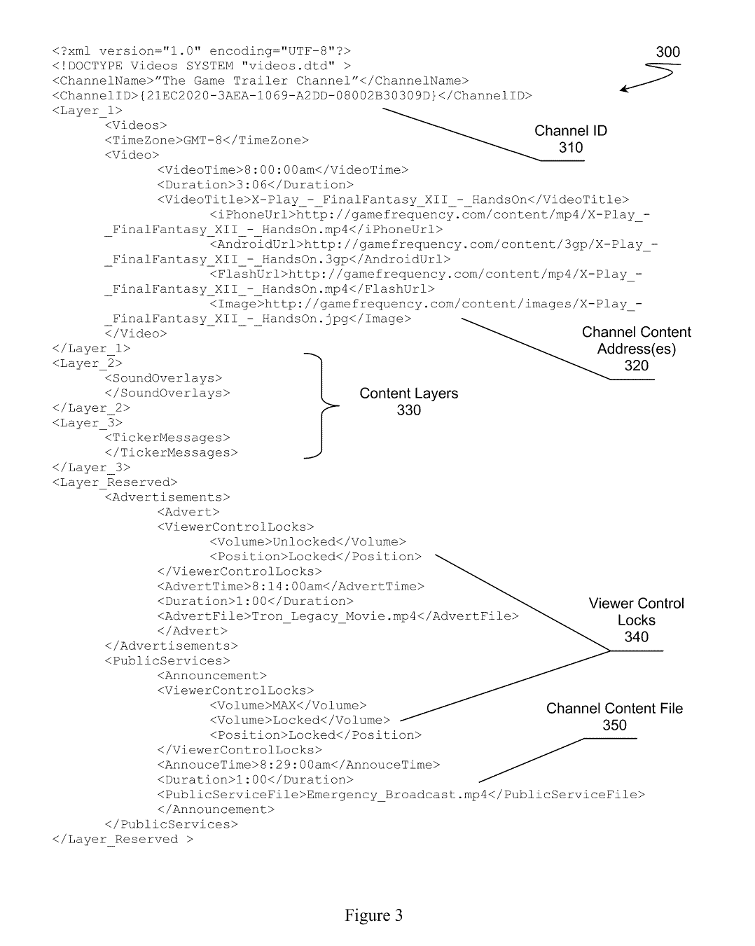

At any point in time the producer can use controls 250 to save, cancel, compile, broadcast, release, or otherwise manage the arrangement of their channel. Saving a channel is considered to include archiving a current arrangement for the channel in the channel database. Compiling a channel represents instructing the channel server to generate one or more media player commands comprising instructions for a media player on how to present the identified media content as discussed in reference to FIG. 3. When the producer is ready to release the channel, the producer submits the channel for broadcast.

When the channel server compiles a channel arrangement, the channel server combines the producer identified content and the producer defined arrangement into a compiled arrangement of channel content. The compiled arrangement of channel content is at least partially generated according to the arrangement of media content defined by the producer. One should appreciate that the compiled arrangement incorporates the producer's instructions, but is not required to match exactly the producer's defined arrangement. As illustrated, a compiled arrangement can include non-producer identified content 230. Furthermore, the channel server can auto-populate media segments if required or can adjust the schedule to better fit the a priori characteristics of the content (e.g., display size, duration, etc.). For example, a producer might schedule a day's worth of content. The channel server can create a recommendation on actions to take when the schedule is complete, possibly including repeating the schedule, recommending additional content, randomly assigning content from a pool of available content, or other actions.

Although the example in FIG. 2 illustrates use of a channel template limiting a producer's ability to define a channel arrangement, it is also contemplated that the channel portal can offer additional channel arrangement feature sets in exchange for payment. Once a producer pays required fees, the producer can access the additional features. Example features can include adjusting time slots, modifying layers, adding or removing layers, offering access to advertisement slots to others, or other features.

In some embodiments, the channel server provides an auction facility that allows advertisers to bid on having their promotions placed in the producer's channel schedule, possibly in real-time. The winner of an auction can then have their promotion content inserted just-in-time by having the schedule updated. The updated schedule instructs the media player to play the commercial as opposed to default content. The updated schedule and one or more promotional messages can be transmitted to the players (e.g., via push or pull technologies) so that the player can be instructed to play the commercials at the proper time. The inventive subject matter is also considered to include support for advertisers interacting with the system and support for management of advertisement content within a channel arrangement.

Just-in-time advertisements can be generated based on feedback from the media player possible based on ambient data collected via sensors (e.g., micro-phone, GPS, accelerometer, magnetometer, camera, etc.). The channel server can determine if the arrangement should be updated to present a more relevant promotion based on the ambient data. The advertisement can be obtained from an advertisement server configured to provide promotions according the desire characteristics of a target layer. In addition, a just-in-time advertisement could be generated real-in time as a result an auction among advertisers. In such embodiments, the just-in-time advertisements can be considered auto-populated content.

One approach for providing just-in-time advertisement using place holder addresses for advertising content. A place holder address can comprise a URL pointing to the channel server and referencing a file or address on the server where the advertisement is to be located. When the time approaches for playing the advertisement, the channel server can select a file or other object based on various criteria, possibly including ambient data collected from the media player. Then, the media player can obtain the message from the channel server. Such an approach reduces communication overhead and increases relevance of advertisement to a viewer's current circumstance.

### Compiled Channel Arrangements

When the channel server compiles an arrangement, the channel server generates one or more media player commands governing how the channel content should be presented to a viewer. FIG. 3 illustrates example compiled arrangement 300 embodied as a serialized XML file comprising a plurality of content layers 330. The channel server has combined the producer identified content, non-producer identified content, and producer defined arrangement information (e.g., the schedule) into a format understandable by one or more models of media players. As illustrated, compiled arrangement 300 includes media player commands for a heterogeneous mix of media players as indicated by channel content addresses 320. The media player commands are bound to compiled arrangement 300 where the media player command instruct media players how to play the channel content. Preferred media player commands also comprise viewer control locks 340 which instruct the media player to restrict a viewer's control over playing at least a portion of the channel content.

Compiled arrangement 300 is preferably managed as a distinct object from channel content. Such an approach allows for real-time updates of the channel without incurring substantial communication overhead. When the media player receives an updated compiled arrangement, possibly as an updated file or even as changes in a serialized stream, the media player can take immediate action to present updated channel content.

In some embodiments, a channel can be identified with channel identifier 310, or other type of media code, that allows the channel server to identify the channel. When the server receives a request for the channel where the request includes channel identifier 310, the server can look-up the compiled arrangement and content based on channel identifier 310, then send the compiled arrangement and possibly the content to the media player. If a viewer wishes to subscribe to a new channel, they can purchase access to a new channel identifier 310. An approached based on channel identifier 310 reduces communication overhead so a device does not have to constantly request new content, unless necessary. Channel identifier 310 is represented as a GUID in FIG. 3. In some embodiments, channel identifier 310 identifies a unique channel-media player combination, which provides for customization of non-producer identified content to a specific media player.

Channel identifier 310 can be represented within an XML file as an embeddable code. The code itself can be a hash value, UUID, GUID, bit fields, or other type of encoding. Preferably the channel identifier 310 uniquely identifies a channel, content, individual, or media player compilation. “Identifier” is used euphemistically to represent an encoding of digital data that can be used to make an association with other objects. The identifier could be single-valued, multi-valued, a data structure (e.g., serialized data, data object, etc.), or other type of encoding.

The XML tags in compiled arrangement 300 provide various media player commands or other information including an absolute play time, duration, a title, a pointer to content as represented by channel content addresses 320, or images. These tags aid in defining the presented arrangement for the channel content. All possible tags or other type of media player commands are contemplated.

Layer content can be encoded as one or more content layers 330. Each layer can be defined as a separate object along with its own requirements or media player commands as desired. In the example shown, there are four layers presented which include videos, sound overlays, tickers, and reserved layer for advertisements and public service announcements. Only the video layer and reserved layer are presented in more detail for clarity and illustrative purposes. The examples represent a small subset of possible types of layers. One should appreciate that any number of layers, subject to the capability of the media players, can be incorporated in the channel's compiled arrangement and appreciate that an individual can define any type of layer beyond those listed. For example, compiled arrangement 300 could also include a haptic feedback layer via haptic actuator technologies include electroactive polymers, piezoelectric, electrostatic surface actuation, movable or rotatable weights, or other types of actuators. Other types of layers can include pop-ups, voice-overs, interactive content, or other types of layers where media content can be played in parallel.

The layers can provide instructions to the media player on where to locate channel content. In the video layer, channel content is identified by channel content addresses 320 in the form of URLs, from which the media player can directly obtain the content. In the reserved layer, content is identified as channel content file 350 in the form of a file name. The file can be located within media player or local to the channel server. Other forms of content address are also contemplated. In some embodiments, content can be addressed by a location in a content buffer where the buffer has been partitioned according to compiled arrangement 300. Rather than referencing content by name, the media player simply plays whatever data has been stored as the buffer address location. Such an approach is useful when schedules remain static, but content changes. Additionally, as referenced above, content addresses 320 could represent a place holder address pointing to the channel server where the channel server insert content at the address just-in-time for presentation, naturally taking into account latency or download timing constraints.

Especially preferred media player commands include viewer control locks 340. Viewer control locks 340 instruct the media player to restrict viewer control over playback of the identified content. For example, for the advertisement the media player is instructed to unlock volume control to allow a viewer to adjust a volume while locking the position of the advertisement. Thus, a viewer is restricted from altering the position of the presented advertisement. In the public service announcement example, the media player is instructed to set the volume to maximum and to restrict a viewer from altering the volume by locking the volume control.

In some embodiments, compiled arrangement 300 can comprise a constructed media player dedicated to a channel. The channel server can also be configured to construct a media player from one or more components based on the information supplied by the producer or other system requirements. The media player can be considered a compilation of components for playing the channel content. In such an embodiment, the media player commands can be bound to the player or the channel in a manner where the player is only capable of playing channel content from the corresponding channel. The inventive subject matter is also considered to include compiling various media player components into an embeddable media player. In some embodiments, owners of the components are automatically provided compensation in exchange for use of their components when constructing or broadcasting a channel-media player construct.

### Transmitting Content

Channel content can be transmitted to media players through different approaches. In some scenarios the channel server can push the channel content to the media player in response to a channel request. In other scenarios the media player can pull the content from remote content sources by leverage the content addresses in the compiled arrangement. When the channel server transmits the content for the channel, the server can access content locally, possibly within a media content database, or from remote sites. The server prepares the content for transmission, possibly by analyzing or editing the content for presentation. Once prepared, the content or compiled arrangement can be sent to the subscribers over a network (e.g., Internet, WiFi, 3G, 4G, etc.). Example methods of broadcasting can include unicasting to each subscribing media player, multicasting to multiple players, or otherwise ensuring channel content is delivered to a subscribing player.

Content of a channel can be transmitted via differing schemes. A preferred method is to serialize the content using a markup language (e.g., XML) and sending the content over a network (e.g., Internet, 3G, 4G, etc.) to subscribing devices. One should appreciate that the content could be sent as separate objects or streams separate from compiled arrangement 300.

### Media Player Buffers

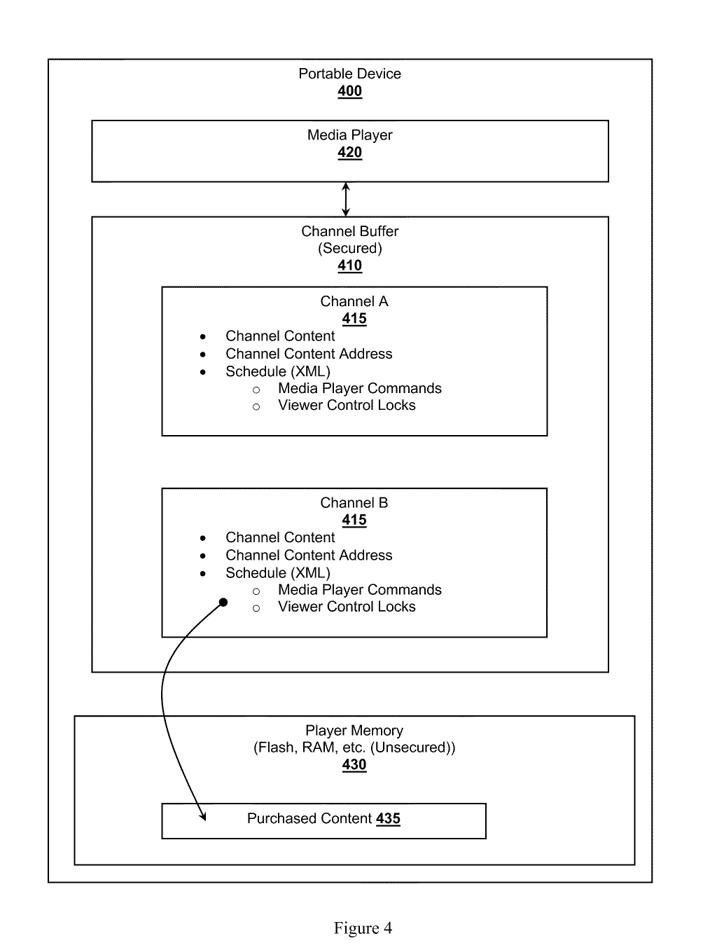

Media player devices are expected to buffer content within a buffer, and then play the content only when dictated by the compiled arrangement as represented in FIG. 4. This approach aids in protecting rights of the content owners and ensures that all subscribers see the same content substantially at the same time. As such, a compiled arrangement includes an embedded channel content schedule, which can be embedded within the XML serialized stream or could be sent via a different stream or simply as a single data file. Additionally, the disclosed approach does not require extreme synchronization schemes. Some differences in playback times across media players are considered acceptable. Typically, differences of less than 30 seconds would be considered acceptable, although differences of less than 10 second differences are more preferable. Synchronization can be achieved through communication with the channel server, collected GPS data, or other time server.

Portable device 400 can represent various types of computing devices including cell phones, game systems, or other types of portable devices. Media player 420 represents a module, possibly an app, configured to access channel buffer 410 storing compiled arrangements and content for one or more of channels 415. In a preferred embodiment, channel buffer 410 is secured against unauthorized access.

One aspect of the inventive subject matter is considered to include content management within channel buffer 410. Buffer management can include organizing content appropriately, deleting played content, overwriting content, protecting content from being overwritten, increasing the buffer size, authenticating access to buffered content, or other types of buffer management. The media player is able to present the content only according to the compiled arrangement, while channel buffer 410 is secured from access by a viewer of the content. The buffer could be secured according FIPS 140-2 or similar security requirements.

As media player 420 presents channel content, the viewer can be offered opportunities to purchase channel content or other items. Upon receipt of payment, the channel server can present media player 420 one or more authorized channel content buffer management commands. For example, an authorized buffer management command can include instructions to copy purchased content 435 from the secured channel buffer 410 to a user accessible player memory 430, which can be unsecured. For example, a purchased video could be moved to a flash card.

Buffered content can remain in the channel buffer 410 until it is played or replaced. Once played, the content can be deleted or overwritten to free space for subsequent content. Channel buffer 410 store channels 415 within a circular buffer where media player 420 accesses content in the circular buffer based on the instructions of the schedule and while played content is updated or replaced.

Another aspect of the inventive subject matter is considered to include methods by which a compiled arrangement references channel content within channel buffer 410 or not yet stored in channel buffer 410. In some embodiments, the compiled arrangement can identify content via file system references. It is also contemplated that the compiled arrangement can point into the content at arbitrary points to ensure that the scheduled timing requirements are maintained. For example, the compiled arrangement might dictate that a video should be displaying a specific frame at a specific time as required by the compiled arrangement. Media player 420 would respond by accessing the specific frame as referenced by the compiled arrangement and display the frame accordingly even if the player must play the frame out of sequence or otherwise time-sift the video. Such an approach provides for a stricter adherence to a schedule, if desired by a channel owner and further enhances a communal synchronized viewing environment.

Media player 420 follows the commands of the compiled arrangement by presenting the content as instructed at specified times. The specified times can be absolute times, as obtained from GPS, internal device clock, or external clock. It is also contemplated that times could be relative times, possibly based on an offset or a start time. In an embodiment simulating television, it is expected that the content will be played at absolute times so that all viewers of the content see the content at substantially the same time.

Media player 420 follows the prescribed schedule unless an update to the schedule is received. The media player could poll the channel server for compiled arrangement updates, possibly every second, five seconds, a minute, or other time periods. It is also contemplated that the media player could receive a push from the channel server possibly via a WebHook, PubSubhubbu, Reverse HTTP, or other form of callback.

It should also be stressed that the content can be buffered then played as opposed to merely playing content as it is received. The benefit of this approach allows users to download content when connectivity is solid, and then play the content according the schedule when connectivity is weak.

### Viewer Experience

One should appreciate the above disclosed techniques provide for a rich, dynamic viewer experience where content can be provided and buffered based on the capabilities of the media player, network, or other infrastructure rather than merely broadcasting as is traditionally done. By binding the media player with channel compiled arrangements of channel content, the viewer experiences a television-like environment. Furthermore, the content can remain under control of the content owner because the media player's buffers can be secured from viewer access.

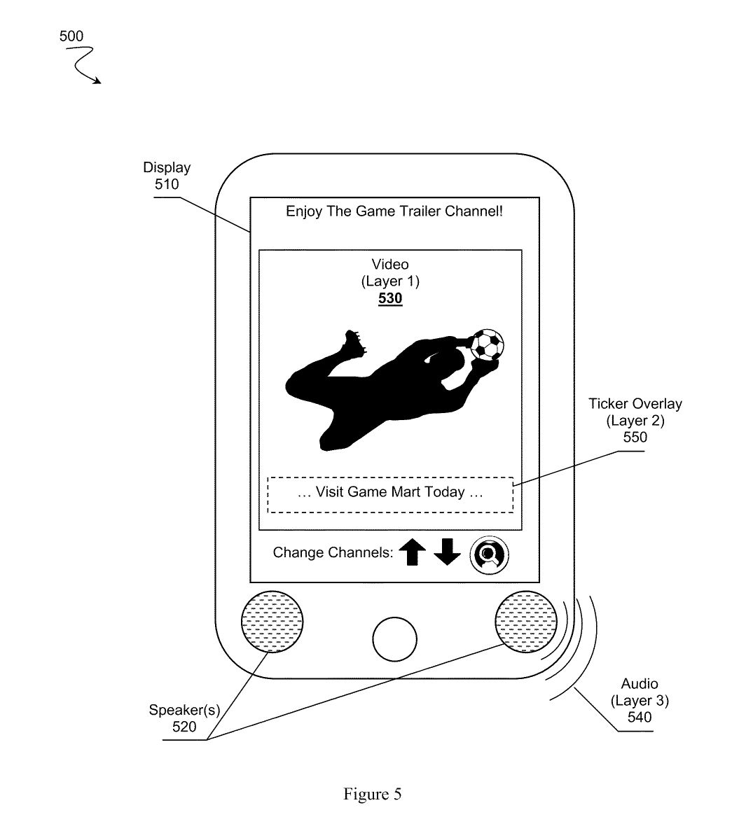

FIG. 5 illustrate portable device 500 operating as a media player presenting layered channel content to a viewer. Portable device 500 can include display 510 and speakers 520 for presenting image and audio data, respectively. The media player has requested a channel called “The Game Trailer Channel”, which comprises multiple layers of channel content. For example, video layer 530 presents videos in a portion of display 510 according the schedule within the compiled arrangement of the channel. The channel also includes ticker overlay 550, which is superimposed over video layer 530. Furthermore, a non-visible layer is presented as audio layer 540, which can include audio data from sources other than the video currently being displayed. Thus the user experiences a rich media environment substantially at the same time as other viewers of the channel.

The viewer experience can be further enhanced. For example, a viewer subscribing to multiple channels can be presented a channel changing interface to simulate channel surfing. Furthermore, the channel server can construct a channel list for the media player so the viewer can see the schedule of channel content on all subscribed channels. Still, further, channel content can be tagged with metadata or attributes, which the channel server can utilize to identify and to recommend additional channels to the viewer.

The viewer experience can be interactive as well. Content can also include interactive content including on-line interactions, games, applications, or other types of interactive content. For example, a viewer could purchase a currently playing video possibly offered through ticker overlay 550. The video could be purchased and copied directly from a secured buffer, assuming proper authorization, or purchased from the video owner. In some cases, the price for purchasing could be different if obtaining content from the buffer versus from the actual owner or other source. A price difference might be useful to represent differences in quality between buffered content and the original content.

### Additional Considerations

The techniques disclosed above can be considered an “XML Producer” platform where users can package content within XML data streams and control how the content is presented. This approach can be applied to power point presentations, web pages, television, or other types of media. One example of the disclosed techniques include SonicPlayer™ developed by IPGreenhouse (see URL www.ipgreenhouse.com) and made available in February 2010.

Additionally, a service can be created that provides template streams that can be adapted for use as a channel's compiled arrangement (e.g., video channel, music channel, game channels, movie trailers, etc.). An individual could pay to add their content to the blank stream, while the stream has reserved time slots or reserved positions for advertisements as discussed above. Subscribers could pay extra fees to remove advertisements or producers could pay fees to gain control over advertising media segments.

Through the use of the disclosed systems, any individual could create one or more of their own channels on nearly any topic: crafts, games, music, interviews, news, or any other topic. Example uses of the disclosed presentation techniques include: presenting course work according to a curriculum, presenting movies according to movie schedules, presenting purchasable deals similar to a shopping channel, or other types of presentations.

It is also contemplated the scheduling infrastructure could provide channel management capabilities for use by individuals having more than one channel. A producer interface can be presented to allow the individuals to update, schedule, edit, or otherwise manage multiple ones of their channels at the same time. For example, a for-fee cable network (e.g., HBO™, Showtime™, Starz™, etc.) could have more than one channel to distribute their content to mobile devices. The networks could schedule the content to play normally one a first channel, then they could drag and drop the channel schedule onto a second channel. Then the second channel could be time shifted by some amount of time. Essentially the two channels would have the same content just presented at a shifted time, shifted by 30 minutes, for example.

Furthermore the contemplated system can update a channel's schedule in view of changes. For example, if a newly added content does not fit existing time slots, the time slots can be adjusted. The channel server can automatically re-calculate the schedule to make adjustments as necessary (e.g., shifting content, rescheduling advertisements, splitting content, lengthening content, etc.). Alternatively, the channel server could edit the new content to preserve the existing schedule, or present recommendations on how to edit the content to fit the existing schedule. The server could also present scheduling recommendations.

The contemplated system could also be configured to support time-shifting including pause, fast forward, rewind, or other types of control over the buffered content. It more preferred embodiments such features would have restricted use via viewer control locks and a subscriber would pay fees to gain access to such capabilities. A channel subscriber can access channel server via a subscriber interface to adjust restrictions of the viewer control locks in exchange for a fee. The viewer control locks can be disabled or removed from the channel's compiled arrangement.

Yet another inventive concept includes presenting content as a virtual environment that would be considered larger than the capabilities of the media player. The media player could then represent a window into the virtual environment. Based on sensor information (e.g., GPS, compass, accelerometer, etc.), the media player would present the appropriate content based on the sensor information and according to the schedule. One could utilize these capabilities to allow viewers to walk into an hour long show. The viewer can pan their media player device around the environment of the show to view the unfolding content, a crime scene for example. The next time the viewer watches the show, they might chose to watch from a different perspective to enjoy the content again. Such an approach could be mapped to gaming platforms easily.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A media channel distribution portal, the portal comprising:
a channel database configured to store a compiled arrangement of channel content;
a channel producer interface through which a channel producer constructs a channel by identifying media content and defining an arrangement of the media content within the channel where the arrangement comprises a schedule for playing the media content; and
a channel server coupled with the programmed channel database and the channel producer interface, and configure to:
compile the media content according to the arrangement into a compiled arrangement of channel content, the compiled arrangement having a broadcast schedule;
bind the compiled arrangement with media player commands instructing remote media players how to play the channel content according to the compiled arrangement, the player commands comprising a viewer control lock restricting control over play of a portion of the channel content; and
broadcast the channel content and the media player commands within the channel over a network to at least one of the remote media players.

2. The portal of claim 1, wherein the remote media player commands target a heterogeneous mix of players.

3. The portal of claim 1, wherein the channel comprises an a priori defined arrangement having pre-encoded media player control commands.

4. The portal of claim 3, wherein the a priori defined arrangement comprises blank media segments.

5. The portal of claim 1, wherein the compiled arranged of channel content comprises non-producer identified content.

6. The portal of claim 5, where the viewer control lock restricts viewer control over playback of the non-producer identified content.

7. The portal of claim 5, where in the non-producer identified content comprises at least one of the following: a public service announcement and a just-in-time advertisement.

8. The portal of claim 1, wherein the channel server is further configured to reference the media content from remove content sources over a network.

9. The portal of claim 8, wherein the channel server is configured to aggregate the media content from the remote content sources.

10. The portal of claim 8, wherein the media player commands instruct the media player to obtain the channel content directly from the remote content sources.

11. The portal of claim 1, wherein the compiled arrangement of channel content comprises a plurality of content layers.

12. The portal of claim 11, wherein the viewer control lock restricts viewer control over playback of at least one of the plurality of content layers.

13. The portal of claim 1, wherein the compiled arrangement of channel content comprises auto-populated content.

14. The portal of claim 1, further comprising a subscriber interface configured to allow a channel subscriber to adjust restrictions of the viewer control locks.

15. The portal of claim 1, wherein the media player commands comprises authorized channel content buffer management commands.

16. The portal of claim 15, wherein the authorized channel content buffer management commands includes copying a purchased portion of the channel content from a secured buffer to an unsecured memory of the media player.

17. The portal of claim 1, wherein the broadcast schedule of the compiled arrangement includes absolute playtime requirements for the channel content.

18. The portal of claim 1, wherein the compiled arrangement includes display position requirements for the channel content.

19. The portal of claim 1, wherein the compiled arrangement includes orientation requirements for the channel content.
